(19) United States
(12) Patent Application Publication
(10) Pub. No.: US 2026/0061394 A1
(43) Pub. Date: Mar. 5, 2026

(54) HYDROPHOBIC INTERACTION CHROMATOGRAPHY (HIC) COMPOSITION AND METHOD OF PRODUCING THE HIC COMPOSITION

(71) Applicant: Advanced Materials Technology, Inc., Wilmington, DE (US)

(72) Inventor: Barry Edward Boyes, Wilmington, DE (US)

(21) Appl. No.: 19/104,589

(22) PCT Filed: Jun. 30, 2023
(86) PCT No.: PCT/US2023/026685

§ 371 Date: Feb. 18, 2025

Related U.S. Application Data
(60) Provisional application No. 63/403,548, filed on Sep. 2, 2022.

(51) Int. Cl. B01J 20/32; B01D 15/32; B01J 20/288; B01J 20/289

(52) U.S. Cl. CPC B01J 20/3219; B01D 15/327; B01J 20/288; B01J 20/289; B01J 20/3227; B01J 20/3274

(57) ABSTRACT

A hydrophobic interaction chromatography (HIC) composition includes a solid phase substrate and a hydrophobic-modified hydrophilic ligand covalently coupled to the solid phase substrate. The hydrophobic-modified ligand includes a hydrophilic ligand portion covalently bonded to the solid phase substrate with the hydrophilic ligand portion including a polar group and a plurality of hydroxyl groups. The hydrophobic-modified ligand also includes a peptide segment covalently coupled to the hydrophilic ligand portion and comprising from two to twenty amino acid residues. The peptide segment is linearly arranged, and each amino acid is the same as or different than the other amino acid residues for promoting HIC interaction.

### CROSS-REFERENCE TO RELATED APPLICATIONS

This application claims the benefit of and priority to U.S. Provisional Patent Application No. 63/403,548, filed Sep. 2, 2022, which is incorporated herein by reference in its entirety.

### GOVERNMENT SUPPORT

This invention was made with government support under GM140789 awarded by the National Institutes of Health. The government has certain rights in this invention.

### FIELD OF THE DISCLOSURE

The present disclosure generally relates to a chromatographic composition for use in hydrophobic interaction chromatography.

### BACKGROUND

Hydrophobic interaction chromatography (HIC) is a chromatographic method that employs salt solutions, generally in aqueous conditions, to bring about the reversible association of molecules with a suitably modified surface. A conventional application is to employ HIC for biomolecule separations, to effect isolation of a target biomolecule, or class of biomolecules, or to conduct analysis of a mixture of such molecules. Recently, the method has become favored for separations of protein biomolecules, as it can be conducted under conditions that are considered mild, or less likely to disrupt native, biologically functional, protein structures. The application of HIC is not limited to proteins, and has been applied to other biomolecules, including carbohydrates, nucleic acids, and complex molecular assemblies, including biomolecular complexes, conjugates, subcellular organelles, viruses and the like. The features of the method can be complex, with a variety of potential or known interactions occurring between the targets of interest, the chemically modified chromatographic surface, and solvent or solvent additives used to manipulate the separation. In broad terms, the purpose of the chromatographic material in a separation is to encourage the differential migration of chemical species in space and time, in response to a flow of material within a defined device or condition. Thus, the composition of the flowing stream, commonly referred to as the mobile phase, the rate of transfer of the mobile phase, structure and composition features of the sample, and features of the chromatographic surface, commonly referred to as the stationary phase, as well as external features, such as temperature of operation, all define the nature of the separative process. The features of the chromatographic surface of the stationary phase, including particular features of the chemical structure of the surface, define the associations of the sample elements with the surface, relative to the probability that the sample elements will remain in the flow stream. However, conventional stationary phases for HIC are known to have utility limitations for separating proteins and other biomolecules. Thus, there remains an opportunity to develop an improved composition useful as a stationary phase for HIC.

### SUMMARY OF THE DISCLOSURE AND ADVANTAGES

In one aspect of the present disclosure, a hydrophobic interaction chromatography (HIC) composition includes a solid phase substrate and a hydrophobic-modified hydrophilic ligand covalently coupled to the solid phase substrate. The hydrophobic-modified ligand includes a hydrophilic ligand portion covalently bonded to the solid phase substrate with the hydrophilic ligand portion including a polar group and a plurality of hydroxyl groups. The hydrophobic-modified ligand also includes a peptide segment covalently coupled to the hydrophilic ligand portion and comprising from two to twenty amino acid residues. The amino acid residues may include both natural and non-natural amino acids. The peptide segment is linearly arranged and each amino acid residue is the same as or different than the other amino acid residues for promoting HIC interaction.

In another aspect of the present disclosure, a method of producing a HIC composition for hydrophobic interaction chromatography is provided. The method includes providing a solid phase substrate and a hydrophilic ligand including a polar group and a plurality of hydroxyl groups. The method also includes reacting the solid phase substrate and the hydrophilic ligand to covalently couple the hydrophilic ligand to the solid phase substrate to form a hydrophilic-modified substrate. The method further includes providing an activation compound including a leaving group and reacting the activation compound with one of the plurality of hydroxyl groups of the hydrophilic-modified substrate to form an activated hydrophilic-modified substrate. The method further includes providing a peptide segment comprising from two to twenty amino acid residues derived from an amino acid. The peptide segment is linearly arranged, and each amino acid residue is the same as or different than the other amino acid residues for promoting HIC interaction. The method further includes reacting the activated hydrophilic-modified substrate with the peptide segment to release the leaving group of the activation compound and form the hydrophobic-modified hydrophilic ligand and the HIC composition.

The HIC composition is useful for HIC separations of proteins and various biomolecules due to the balance and location of hydrophilic and hydrophobic interactions in combination with minimized ionic interactions.

### BRIEF DESCRIPTION OF THE DRAWINGS

Advantages of the present invention will be readily appreciated, as the same becomes better understood by reference to the following detailed description, when considered in connection with the accompanying drawings.

FIG. 1 is an overlay of chromatograms showing the separation of nucleobases with a control (3TPG) stationary phase and stationary phases formed from the HIC composition.

FIG. 2 is an overlay of chromatograms showing the separation of lysozyme and trastuzumab with a control (3TPG) stationary phase and stationary phases formed from the HIC composition.

### DETAILED DESCRIPTION OF THE DISCLOSURE

The present disclosure provides a hydrophobic interaction chromatography (HIC) composition. The HIC composition is useful for HIC separations. For example, the HIC composition is useful as a stationary phase in HIC separations.

The HIC composition includes a solid phase substrate and a hydrophobic-modified hydrophilic ligand covalently coupled to the solid phase substrate. The hydrophobic-modified hydrophilic ligand includes a hydrophilic ligand portion covalently bonded to the solid phase substrate, and a peptide segment directly or indirectly coupled to the hydrophilic ligand portion. In other words, the peptide segment modifies the hydrophilic nature of the hydrophilic ligand portion.

The hydrophilic ligand portion includes a polar group and a plurality of hydroxyl groups. The polar group of the hydrophilic ligand portion may be selected from a carbonate, a carbamate, an amide, an amine, a ureido, an ether, a thioether, a sulfinyl, a sulfoxide, a sulfonyl, a thiourea, a thiocarbonate, or a thiocarbamate. The aforementioned functionality may also be included in a heterocyclic compound. For example, the polar group may be an aromatic ring including an amine. In one aspect, the polar group is selected from an amide or a carbamate. The plurality of hydroxyl groups present on the hydrophilic ligand portion may be 2 or more hydroxyl groups. Alternatively, the hydrophilic ligand portion may include 2 to 8, 2 to 7, or 3 to 5, hydroxyl groups.

Referring first to the solid phase substrate, although not required, the solid phase substrate is typically silica. The silica used for the HIC composition is not limited to any particular grade. Both nonporous spherical silica and porous silica, including superficially porous silica, may be used. The silica particles typically have an average diameter particle size of from 0.5-100 μm, from 1-50 μm, from 1.5-10 μm, or from 1.7-5 μm. The porous silica may have an average pore diameter of greater than or equal to about 80 Å, greater than or equal to about 250 Å, greater than or equal to about 300 Å, greater than or equal to about 450 Å, from 200 to 1,000 Å, from 250 to 900 Å, or from 300 to 850 Å. Alternatively, although pore diameters below 70 Å are typically avoided, it is contemplated that the average pore diameter may be from about 1 to about 50 Å, from about 5 to about 40 Å, or from about 10 to about 30 Å. The surface of the silica particles typically includes silica hydroxyl groups, so-called silanols, which are useful for covalent coupling of various reagents to the silica surface, such as the hydrophilic ligand portion. Mostly commonly, specific organosilane reagents are employed for these silica surface modifications to form a covalently-attached bonded phase. Suitable grades of silica are available under the tradename Halo Fused-Core® Silica from Advanced Materials Technologies having a principal place of business in Wilmington, DE, but many silica materials are widely available as commercial materials for a variety of useful applications. Alternative substrates include hybrid inorganic/organic material. Within the context of this disclosure, the term “hybrid inorganic/organic material” includes inorganic-based structures wherein an organic functionality is integral to both internal core (i.e., inorganic structure) as well as the hybrid material surface. The inorganic portion of the hybrid material may be, e.g., alumina, silica, titanium, cerium, or zirconium or oxides thereof, or ceramic material. Further alternative substrates include completely organic substrates that include hydroxyl groups at the surface of the organic substrate. In certain embodiments, the solid phase substrate is formed from carbohydrates. Alternatively, carbohydrates could be included when covalently bonded to inorganic or hybrid inorganic/organic materials. In other embodiments, the solid phase substrate is not formed from carbohydrates.

Although not required, the hydrophobic-modified hydrophilic ligand may be represented by Formula I:

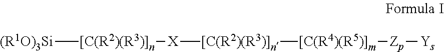

wherein:
X is the polar group;
Z is a connecting group;
Y is the peptide segment;
nis 1-6;
n′ is 0-2;
m is 2-8;
p is 0 or 1;
s is 1;
R¹, R², R³, is independently H or a straight or branched, substituted or unsubstituted, C1 to C18 alkyl group; and

R⁴ and R⁵ is independently H or OH and at least two m units include at least one hydroxyl group. It is to be appreciated that the phrase “m units” throughout this disclosure is merely a convenient reference to the repeat unit with the subscript “m” in Formula I.

When the hydrophobic-modified hydrophilic ligand is represented by Formula I, the hydrophilic ligand portion is represented by Formula la:

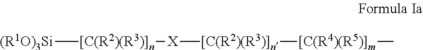

X is the polar group;
n is 1-6; and
n′ is 0-2;
R¹, R², R³, is independently H or a straight or branched, substituted or unsubstituted, C1 to C18 alkyl group; and
R⁴ and R⁵ is independently H or OH and at least two m units include at least one hydroxyl group.

Although not required, typically p is 1 such that the connecting group Z is present in the hydrophobic-modified hydrophilic ligand.

The polar group X is independently chosen from a carbonate, a carbamate, an amide, an amine, a ureido, an ether, a thioether, a sulfinyl, a sulfoxide, a sulfonyl, a thiourea, a thiocarbonate, or a thiocarbamate, including heterocyclic compounds including the polar functionality. For example, the polar group may be an aromatic ring including an amine. In one aspect, the polar group X is selected from an amide or a carbamate. In another aspect, the polar group X is an amide. When the polar group X is an amide, the hydrophobic-modified hydrophilic ligand may be represented Formula Ib:

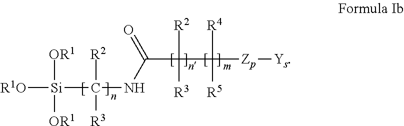

In certain aspects of Formula I and Formula Ib, n is 2-4, m is 3-6, p is 1, and R¹, R², R³ is independently H or a straight or branched, substituted or unsubstituted, C1 to C6 alkyl group. Although not required n′ is typically 0 when X is an amide. In other aspects of Formula I, when X is a ureido, n′ is 1 or 2. In one aspect of Formula Ib, n is 3, X is an amide, m is 5, and four of the m units include only one hydroxyl group. In one aspect, the hydrophobic-modified hydrophilic ligand is represented by Formula Ic:

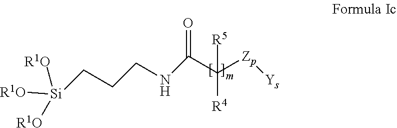

In certain aspects, p is 1 such that the connecting group Z is included in the hydrophobic-modified hydrophilic ligand. Although not required, the connecting group Z is typically a carbamate group when p is 1. In certain aspects of Formula Ic, in which the polar group X is an amide, the connecting group Z is also present, m is 5 with four of the m units including only one hydroxyl group, and the hydrophobic-modified hydrophilic ligand is represented by Formula II:

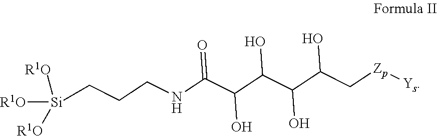

When connecting group Z is a carbamate group, Formula II is further represented by Formula IIa:

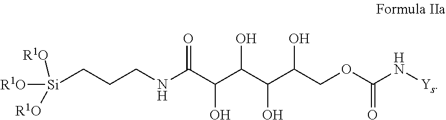

Referring now to the peptide segment, as described above, the peptide segment modifies the hydrophilic ligand portion. The peptide segment is directly or indirectly covalently coupled to the hydrophilic ligand portion. The peptide segment is considered to be directly covalently coupled to the hydrophilic ligand portion when the connecting group Z is not present (i.e., when subscript p is 0). Conversely, the peptide segment is considered to be indirectly covalently coupled to the hydrophilic ligand portion when the connecting group Z is present (i.e., when subscript p is 1). Typically, the peptide segment increases the hydrophobicity of the hydrophilic ligand.

The peptide segment is linearly arranged and includes from 2 to 20 amino acid residues. The amino acids may be selected from natural or non-natural amino acids. Although not required, the peptide segment may also include one or more peptido-nucleic acid (PNA) residues. The peptide segment generally consists of either amino acid residues or a combination of amino acid residues and PNA residues. In other words, in these embodiments, the peptide segment does not include components other than amino acid residues and the optional PNA residues.

Within the context of this disclosure, “linearly arranged” means a bonded chain of amino acid residues and optional PNA residues that are bonded in a linear manner such that cyclic and ring structures are avoided. For example, when the peptide segment consists of 4 amino acid residues, the first amino acid is covalently coupled to connecting group Z, the second amino acid is bonded to the carboxylic acid terminus of the first amino acid, the third amino acid is bonded to the carboxylic acid terminus of the second amino acid, and the fourth amino acid is bonded to the carboxylic acid terminus of the third amino acid. Persons of ordinary skill in the art appreciate that the carboxylic acid terminus of the amino acids participates in the reaction, which is one reason why the amino acids are referred to as amino acid residues once reacted. The peptide segment may include 2, 3, 4, 5, 6, or more amino acid residues. By current methods, peptides longer than about 20 amino acid residues become more expensive to synthesize and purify, which is a current practical limitation. The cost and purity of synthetic or biosynthetic sequences could be addressed by improvements in synthetic procedures in the future. In principle, this is a practical limitation, and not bound by theory of the use of longer peptides for aspects of constructing peptides employed for HIC interactions. It is further known that as peptide or polypeptides are longer, in addition to the synthetic and purification challenges, secondary structure considerations become relevant, as peptides of more than 5-7 amino acids in length can form a variety of stable or somewhat stable structures including helical segments, beta-turns, and the like, depending on the solution environment and amino acid sequences employed. Such structures could be desired, or could prevent desirable HIC interaction potential. In certain aspects, the peptide segment may be 3 to 5 amino acid residues.

The amino acid residues may be chosen from the 20 canonical amino acids that make up protein structures most commonly, known as proteogenic amino acids, and are thus less expensive and more widely employed for biochemical research. A variety of non-canonical amino acids, not commonly present in proteins, may also be used in solid phase peptide synthesis, or in solution phase peptide synthesis, or a combination of these approaches. Peptides and polypeptides may also be produced by biosynthetic process in cells, or in cell-free translation, utilizing various biologic components and enzymatic machinery, along with a suitable RNA template. Such cellular processes, or subsystems derived from cellular processes may also incorporate modified amino acids, non-canonical amino acids, or the like, to build peptide or polypeptide chains. As examples, such non-canonical or “non-natural” or synthetic amino acids can include those with large hydrophobic side chains (aliphatic, aromatic or polyaromatic), side chains with extended or altered hydrocarbon extensions on the side chains (e.g., homo-amino acids) or between the carboxy and amino group (e.g., beta-homo-amino acids), reactive-group protected side chains, optical isomers (residues with D-versus L-optical rotation at the alpha carbon of amino acid structures), and other side chain altered structures (e.g., citrulline, norleucine and the like). These amino acids may be formed by chemical or enzymatic processes as precursors to peptide synthesis, or after synthesis by similar steps or chemical reactions. Similarly, there exists a rich set of examples of chemically similar approaches available for building polypeptide analogs with varied side chains with functional or sequence diversity, including peptidonucleic acids (PNAs), which possess functional properties similar to nucleic acids (hybridization capabilities with nucleic acids), but possess polypeptide backbone features and great structural diversity, can be synthesized using methods similar to peptides, and exhibit chemical characteristics that could be of benefit for promoting selective HIC interactions.

Although not required, typically, at least a majority of the amino acid residues of the peptide segment are neutral at pH values of 3 to 9. The individual amino acid residues that are neutral at pH values of 3 to 9 promote hydrophobic interaction. In addition, not only do the individual amino acids that are neutral at pH values of 3 to 9 promote hydrophobic interaction, such amino acids also minimize potential ionic interaction, and thus ion exchange chromatographic (IEX) retention mechanisms. Although mixed-mode HIC and IEX properties could be employed for manipulating chromatographic selectivity, optimization of separations may become more complex. In selection of a majority of the individual amino acids of the peptide segment as neutral at pH values of 3 to 9, the peptide segment as a whole can be considered to more uniformly promote hydrophobic interactions, when employed to modify the hydrophilic ligand portion of the stationary phase.

Persons of ordinary skill in the art will appreciate that a majority means more than 50% of the amino acids present in the peptide segment are neutral at pH values of 3 to 9. For example, when the peptide segment includes 4 amino acid residues, at least 3 of the individual amino acid residues are neutral at pH values of 3 to 9. In certain aspects, more than 75% of the individual amino acid residues are neutral at pH values of 3 to 9. In other aspects, only one of the amino acid residues included in the peptide segment is not neutral at pH values of 3 to 9. In other aspects, each amino acid residue included in the peptide segment is neutral at pH values of 3 to 9.

HIC utilizes hydrophobic interactions that occur between the analyte target (whether for preparative or analysis purposes of the separation) and the stationary phase surface. These interactions are promoted by elevated ionic strength, with the preferred use of specific salts, or the interactions are decreased by the presence of a polar organic solvent (for example isopropanol, methanol, ethanol, acetonitrile, and the like) added to the mobile phase. In certain circumstances, both salts and organic solvents may be added to the mobile phase in combination. Most often, HIC is initiated by sample presentation to the HIC process at high ionic strength (high salt), which decreases with increasing volume of mobile phase delivered, often in a controlled fashion of mixed proportions of the high and low ionic strength components delivered over time. These gradient elution schemes can employ both a decrease in ionic strength in development of the separations, but also an increase in organic solvent concentration, or either, to elicit separation of components of the sample. In addition to the manipulation of the properties of the mobile phase for HIC, a critical element in the strength of the hydrophobic effects promoting retention of the analyte is the localized or global hydrophobicity of the ligand on the stationary phase of the separative process. In the current circumstances, this hydrophobicity is intended to be supplied by the peptide segment that is covalently bound to the stationary phase, via the connecting group and hydrophilic ligand, to the chromatographic surface. Amino acid side chains, and peptides or polypeptides formed from amino acids or the like, can be described as hydrophobic or less hydrophobic, based on relative scales of hydrophobicity that are well known in the scientific literature. Such relative hydrophobicity scales include scales for equilibrium partitioning of the amino acids, peptides or polypeptides between water and a highly hydrophobic immiscible organic solvent, octanol, known as the water/octanol partitioning coefficient. Each of the amino acids, or the like, may have their side chain hydrophobicity properties thus ranked one to the other, or relative to reference compounds that can describe hydrophobicity as a chemical property. Similarly, the peptides built from such amino acid blocks, or the like, may be measured, or even computed, from the hydrophobicities of the constituent amino acids, when adjusted for the formation of the amide backbone structure in the peptide or polypeptide chain, or the presence of free terminal charge groups of the peptide or polypeptide (free amino- or carboxy-terminii). Although the water/octanol partitioning coefficients may not reveal particular biological meaning to the amino acids, or the polypeptides built from these components, strong correlations are known to predict the propensity of such side chain or composition-driven hydrophobicities to be preferred for non-polar biological environments, such as occur in protein segments traversing a biological membrane, or which occur in polypeptide sequences occupying interior domains of protein molecules, or hydrophobic patches of residues that may occur on the surface of proteins. The propensity of hydrophobic side chains to be preferred in hydrophobic environments (such as membrane interiors) correlates well with physiochemical scales, such as the water/octanol partitioning coefficient. Thus, hydrophobicity in the context of peptide sequences, can be defined as a property of a given peptide sequence, or measured or computed as a local peptide sequence property of a longer peptide, polypeptide or protein sequence. Therefore, discussion of the hydrophobicity of a peptide sequence needs to be considered in the context of the global property for a complete sequence, or as a localized feature of a shorter segment within the structure of a peptide or polypeptide sequence, as may be present within a longer sequence. Longer sequences may be designed with patches of highly hydrophobic sequences, formed by consecutive hydrophobic residues, interspersed with less hydrophobic sequences. The utility of such arrangements may provide useful properties (HIC retention, selectivity of separations, or even band widths of eluting analytes) that would not be revealed considering only the global hydrophobicity of the entire peptide sequence (averaged across all residues), such as may be employed as the covalently bound peptide segment in the current invention. At present, no theory known to the inventor predicts localized or nearest neighbor effects of stationary phase bound peptide amino acid sequence on HIC retention, separation selectivities or band broadening relationships. A reasonable inference is that such chromatographic performance properties could be affected by specific, or local, sequence arrangements, within the context of a longer peptide segment sequence employed as the peptide segment ligand bound to the stationary phase for HIC.

Typically, the entire peptide segment will be neutral at pH values of 3 to 9 when the c-terminus is blocked, and the n-terminus participates in covalent bond formation with the connecting group. The c-terminus blocking agent is not particularly limited and may be any compound that is capable of reacting with the carboxy acid of the c-terminus to form a stable chemical bond. Typically, the c-terminus is blocked with an amide to result in a carboxyamide reaction product, which will not be ionized, but will be chemically stable, under mobile phase conditions typical for HIC separations. More hydrophobic c-terminus carboxyamides may be selected, with longer aliphatic chains or aromatic compositions, should these exhibit utility for HIC separations performance.

The amino acid residues of the peptide segment are typically derived from amino acids selected from the group of glycine (Gly), leucine (Leu), alanine (Ala), Isoleucine (Ile), valine (Val), methionine (Met), cysteine (Cys), proline (Pro), phenylalanine (Phe), tryptophan (Trp), tyrosine (Tyr), and combinations thereof. In one aspect, the amino acid residues are derived from amino acid units selected from the group of glycine (Gly), leucine (Leu), and combinations thereof.

In certain aspects, the peptide segment is selected from the group of:

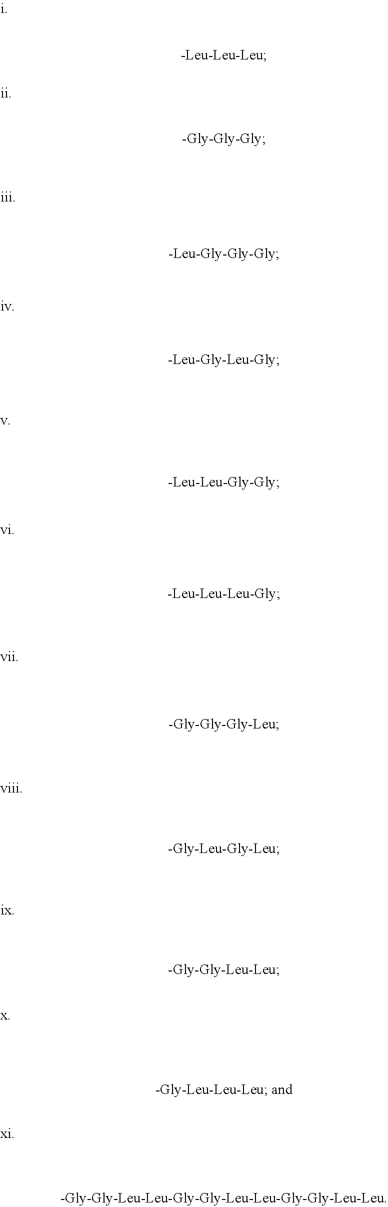

When the c-terminus of the peptide segment is blocked with an amide (AM), the aforementioned peptide segment is selected from the group of:

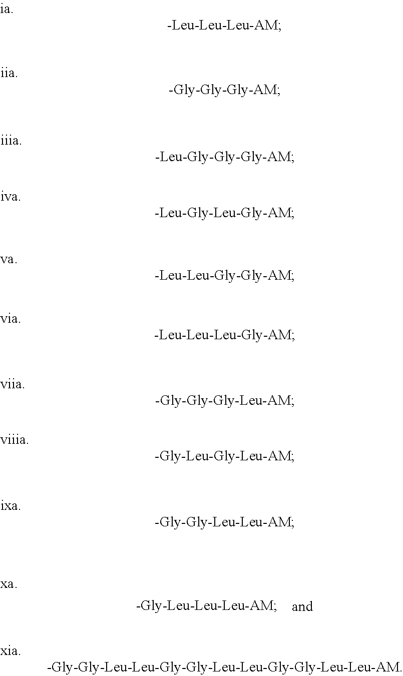

In certain aspects, the hydrophobic-modified hydrophilic ligand is represented by Formula Ila and Y is represented any one of the peptide segments of i.-x. or ia-xa. shown above.

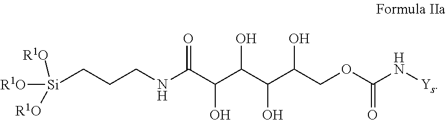

Additional peptide segments different than i.-.xi are also contemplated and can be customized based on the target molecules requiring separation. In particular, on the basis of this disclosure, peptide segments can be chosen considering the following characteristics. The peptide segment can be a linear arrangement of 2-20 amino acid residues, which permits efficient synthesis and purification. Peptide segments of shorter length are generally less likely to favor stable high affinity bio-specific interactions, for example with recognition regions in antibodies or specific protein-protein interaction sites. Amino acid composition can be selected for sequences that avoid known protein-protein interaction sequences, or common epitopes used for eliciting immune reactions or immunochemical associations, based on searching protein sequence data bases that are readily available as public repositories of protein sequences, or are predicted as protein sequences based on reverse translation of genomic sequence databases. Because the HIC peptide segment composition is specifically designed for hydrophobic interaction chromatography, bio-specific interactions not desired, and sequences selected for such recognition properties can be avoided. In addition, at the N-terminus, the site at which the hydrophobic peptide segment reacts for immobilization with the linking group or hydrophilic ligand portion, the side chain should not have steric interference with the reaction to form the coupling site, suggesting a preference for glycine (H-side chain), or alanine (CH3-side chain) as preferred amino acids, although it is possible that amino acids with “larger” side chains could be tolerated. Hydrophobic amino acids include glycine (Gly), alanine (Ala), valine (Val), leucine (Leu), isoleucine (Ile), proline (Pro), phenylalanine (Phe), methionine (Met), and tryptophan (Trp). Met or Trp can be chemically modified, for example by via oxidation, and as less stable amino acid building block, are less favored. Neutral polar amino acids include asparagine, (Asn), Glutamine (Gln), cysteine (Cys), serine (Ser) and threonine (Thr), and these vary somewhat in hydrophobicity scale properties. Cysteine can be readily chemically modified, by oxidation for formation of disulfide bridges, and as a less chemically stable amino acid is less favored, unless specific structures may be defined to be beneficial for HIC properties (eg., disulfide bridges polypeptides). Amino acids with side chains that can be protonated or deprotonated to form a charge (electric charge) may exhibit ionic interactions, instead of the neutral interactions sought for hydrophobic interaction chromatography. Thus, it is preferred to avoid amino acids with side chains that can be protonated or deprotonated to form a charge, unless such properties exhibit particular benefit for separations using mixed-mode chromatographic properties, combining HIC and IEX characteristics.

With these formulation guidelines, the following hydrophobic peptide are expressly contemplated, as written in n-terminus-X1-X2-X3-X4-X5 . . . Xn-c-terminus by convention:
X1: gly or ala, or other options.
X2-Xn-c-1: non-ionic, small or large amino acid residues which are hydrophobic.
Xn-c: non-ionic, small or large amino acid residues which are hydrophobic, with the carboxy acid of the c-terminus being blocked with an amide, such as an alkyl-amide group. As previously mentioned, interspersing regions of hydrophobic amino acids and hydrophilic or even ionic amino acids, may in some cases have separations benefits, and are anticipated as potentially useful. Similarly, mixtures of the canonical amino acids, with one or more non-canonical amino acids may have benefits for separations, prevent undesired secondary structures, or confer chemical or enzymatic digestion resistance, should these be required. Similarly, mixtures of one or more PNAs can be employed, with amino acids or the like, as interspersed or intervening residues, or as sequences flanking PNA residues, or the converse case.

Referring back to the HIC composition as a whole, in addition to having the hydrophobic-modified hydrophilic ligand coupled to the solid phase substrate, the HIC composition may also have the described, or a similar hydrophilic ligand (i.e., a hydrophilic ligand without hydrophobic modification) coupled to and/or covalently bonded to the solid phase substrate. In other words, in certain aspects, both the hydrophilic ligand and the hydrophobic-modified hydrophilic ligand are covalently coupled to the solid phase substrate, in varying compositions or mixtures. This mixture could occur as either a purposely intended outcome, or represent incomplete reaction of the hydrophilic ligand to produce a partially reacted population of the hydrophilic ligand with hydrophobic modification by the peptide segment.

The polar group of the hydrophilic ligand may be selected from a carbonate, a carbamate, an amide, an amine, a ureido, an ether, a thioether, a sulfinyl, a sulfoxide, a sulfonyl, a thiourea, a thiocarbonate, or a thiocarbamate, including heterocyclic compounds including the polar functionality. For example, the polar group may be an aromatic ring including an amine. In one aspect, the polar group is selected from an amide, or a carbamate. The plurality of hydroxyl groups present on the hydrophilic ligand may be 2 or more hydroxyl groups. Alternatively, the hydrophilic ligand may include 2 to 8, 2 to 7, or 3 to 5, hydroxyl groups.

In one aspect, the hydrophilic ligand is represented by Formula V:

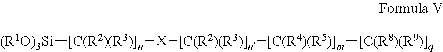

X is the polar group;
n is 1-6;
n′ is 0-2;
m is 2-8;
q is 1;
R¹, R², R³, is independently H or a straight or branched, substituted or unsubstituted, C1 to C18 alkyl group;
R⁴ and R⁵ is independently H or OH and at least two m units include at least one hydroxyl group; and
R⁸ and R⁹ is independently H or OH provided that at least one of R⁸ and R⁹ is OH.

The hydroxyl group of R⁸ and/or R⁹ included in unit q may also be referred to as a terminal hydroxyl group. Those having ordinary skill in the art will appreciate that the hydrophilic ligand portion of the hydrophobic-modified hydrophilic ligand and the hydrophilic ligand share a similar structure, with the exception that the hydrophilic ligand portion does not include unit q (i.e., —[C(R⁸)(R⁹)]_{q}) and thus does not include a terminal hydroxyl group. Accordingly, the hydrophilic ligand may include each of the various structural configurations described above for of the hydrophilic ligand portion with the exception that the hydrophilic ligand further includes the q unit.

In one aspect, the hydrophilic ligand of Formula V is further represented by Formula Va:

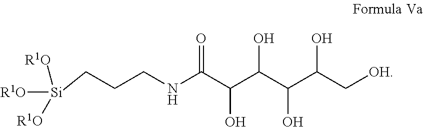

When the HIC composition includes the hydrophilic ligand in addition to the hydrophobic-modified hydrophilic ligand, the relative amount of each ligand can be optimized based on the particular analyte that is the subject of the separation. For example, in certain aspects, the hydrophobic-modified hydrophilic ligand and the hydrophilic ligand are present in a molar ratio range of from of 1:10 to 10:1. Alternatively, the hydrophobic-modified hydrophilic ligand and the hydrophilic ligand may be present in a molar ratio range of from 2:8 to 8:2, from 3:7 to 7:3, from 4:6 to 6:4, or about 1:1. In certain aspects, the solid phase substrate is a superficially porous silica that is covalently boned to the hydrophobic-modified hydrophilic ligand represented by Formula I and the hydrophilic ligand represented by Formula V. Alternatively, in one aspect, the solid phase substrate is a superficially porous silica and is covalently boned to the hydrophilic ligand represented by Formula Va and to the hydrophobic-modified hydrophilic ligand represented by Formula II.

The present disclosure also provides a method of producing the HIC composition. The method includes providing the solid phase substrate and providing the hydrophilic ligand including the polar group and the plurality of hydroxyl groups. In certain embodiments, at least one hydroxyl group is present at a terminus of the hydrophilic ligand, and typically only one hydroxyl group is present at the terminus. Both the solid phase substrate and the hydrophilic ligand are described above. The method further includes reacting the solid phase substrate and the hydrophilic ligand to covalently couple the hydrophilic ligand to the solid phase substrate to form a hydrophilic-modified substrate. The method further includes providing an activation compound including a leaving group and reacting the activation compound with one of the plurality of hydroxyl groups. In certain embodiments, the reaction preferentially occurs with the terminus hydroxyl group of the hydrophilic-modified substrate. Once the reaction between the activation compound and the hydroxyl group occurs, the new composition is referred to as an activated hydrophilic-modified substrate. The terminal hydroxyl group is by design a primary hydroxyl group, whereas in other locations, the hydrophilic ligand possesses secondary hydroxyl groups. This differentiation can permit selective reaction of the primary hydroxyl group relative to secondary hydroxyl groups. In other words, the method includes a first reaction between the solid phase substrate and a second reaction between the reaction product of the first reaction (i.e., the hydrophilic-modified substrate) and the activation compound. Although not common, some degree of reaction may also occur between a secondary hydroxyl group of the hydrophilic ligand portion and the activation compound. The method further includes providing the peptide segment and reacting a free amino terminus of the peptide segment with the activated-hydrophilic-modified substrate to release the leaving group of the activation agent and form the hydrophobic-modified hydrophilic ligand covalently coupled to the solid phase substrate. In other words, the method also includes a third reaction between the reaction product of the second reaction (i.e., the reaction between the activation compound and the hydrophilic-modified substrate) and the peptide segment. The resulting reaction product of the third reaction is the HIC composition including the hydrophobic-modified hydrophilic ligand covalently coupled to the solid phase substrate.

Referring first to the first reaction between the solid phase substrate and the hydrophilic ligand, the reaction occurs between the surface hydroxyl groups present on the solid phase substrate and one of the three [(R¹O)] units present in Formula V:

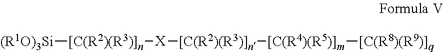

The resulting reaction product produces the hydrophilic-modified substrate and preserves the hydroxyl group in the q unit represented by [C(R⁸)(R⁹)].

Typically, the second reaction between the hydrophilic-modified substrate and the activation compound occurs under aprotic anhydrous solvent conditions, to limit hydrolytic loss of the activated conjugate. The activation compound may include a carbonyl group. Specific examples of the activating compound including the carbonyl group include, but are not limited to, phosgene (carbonyl dichloride), carbonyldiimidazole (CDI), or chloroformates, such as 4-nitrophenyl chloroformate (4-NPC), or carbonates, such as N,N′-disuccinimidyl carbonate (DSC), or a combination thereof. An illustrative example of the second reaction product between the hydrophilic ligand of Formula Va and DSC is provided below, to form the N-hydroxysuccinimdyl (NHS) carbonate of the 3-TPG compound.

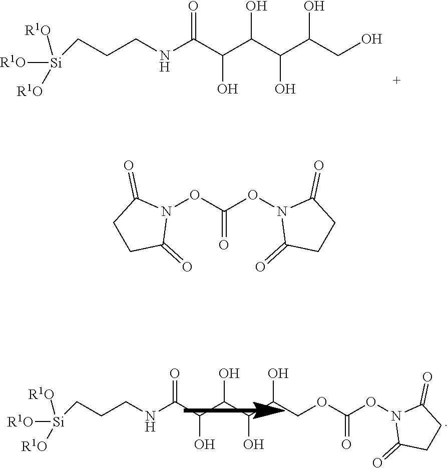

Alternative activation compounds include compounds having a tosylate group, such as, but not limited to, tosyl chloride (4-toluenesulfonyl chloride). Further suitable activation compounds include mesyl chloride (methanesulfonyl chloride), triphenylmethylene chloride (tritylchloride), phosphorus tribromide, or thionyl chloride. Although not typical, any of the reaction compounds can be used in combination with alternative activation compounds.

Without being bound to any particular theory, it is believed that under suitable conditions the activation compounds described herein can selectively react with the terminal hydroxyl group of the hydrophilic ligand. The selective reaction at the terminal hydroxyl group is also considered to be an important aspect of the present disclosure because uniformity and the general avoidance of multiple reaction products, cross-linked intermediates or cyclic carbonates and the like, is favorable to achieving consistent chromatographic separations. Once the hydrophilic ligand is reacted with the activation compound, the hydrophilic ligand portion of Formula Ia is established.

An illustrative example of the third reaction product obtained from reacting the blocked peptide segment -Leu-Gly-Gly-Gly-AM with the reaction product illustrated above is provided below.

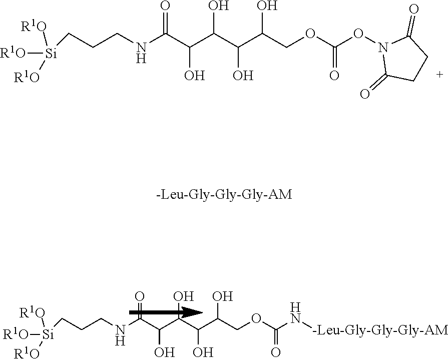

As shown above, the reaction between the second reaction product and peptide segment displaces the leaving group of the activation compound and creates a carbamate (urethane) linkage. The carbamate (urethane) linkage is representative of the connecting group Z in Formula I.

The method of producing the HIC composition may also include coupling both the hydrophobic-modified hydrophilic ligand and the hydrophilic ligand to the solid phase substrate by controlling the stoichiometry of the second reaction. Specifically, after the hydrophilic ligand has been covalently coupled to the surface of the solid phase substrate, the hydrophilic ligand in its current state may be preserved by including fewer moles of the activation compound than the number of moles of the hydrophobic ligand coupled to the substrate. Notably, because the peptide segment will only react with the activated hydrophilic ligand and will not react with the hydrophilic ligand (i.e., non-activated hydrophilic ligand) the remaining hydrophilic ligand is preserved in an unmodified state. As an alternative, the reactions of activation and modification of the hydrophilic ligand can occur in free solution, yielding a mixture, which can thereafter be covalently bonded to a solid phase carrier.

### EXAMPLES

Those skilled in the art will recognize that equivalents of the following instruments and suppliers exist and, as such, the instruments listed below are not to be construed as limiting.

The elemental analysis (% C, % H, % N) values were measured by combustion analysis (Robertson Microlit Laboratories, Ledgewood, NJ). These values were employed to establish ligand coverage measures based on known composition of compounds and Specific Surface Areas (m2/g). The specific surface areas (SSA), specific pore volumes (SPY) and the average pore diameters (APD) of these materials were measured using the multi-point N₂ sorption method (Micromeritics ASAP 2400; Micromeritics Instruments Inc., Norcross, Ga.). The SSA was calculated using the BET method, the SPY was the single point value determined for P/P₀>0.98 and the APD was calculated from the desorption portion of the isotherm using the BJH method. Particle sizes were measured using a Beckman Coulter Multisizer 3 analyzer (30 μm aperture, 70,000 counts; Miami, Fla.). The particle diameter (dp) was measured as the 50% cumulative diameter of the volume-based particle size distribution. The width of the distribution was measured as the 90% cumulative volume diameter divided by the 10% cumulative volume diameter (denoted 90/10 ratio). Generally, values of surface coverage are expressed as normalized to the elemental composition and SSA of samples, to yield molar surface coverage of the silica surface with ligand in μmol/m².

Commercially available 2.7 μm diameter fully hydroxylated superficially porous silica particles (25 g of Halo Silica, Advanced Materials Technologies, Wilmington, DE, SSA=22 m²/g: APD=645 Å) were dispersed while under a blanket of nitrogen, refluxed in toluene (250 mL, Millipore/Sigma, St. Louis, NJ) using a Dean-Stark trap for 1 hour, to collect a small quantity of adsorbed water. After brief cooling to about 65° C., a quantity of 22 mmol of diisopropylethylamine (DIPEA, Sigma-Aldrich, St. Louis, MO) was added with stirring, followed by 66 mmol of N-(3-triethoxysilylpropyl) gluconamide, (3TPG, 30% in ethanol, Gelest Inc., Morrisville, PA). The resulting mixture was heated to 78° C., to remove the bulk of ethanol, then brought to reflux overnight, with occasional collection of about 5 mL portions of solvent to aid removal of the ethanol evolved during bonding of the ethoxy-silane to the surface of the silica particles. After cooling, the resulting silica particles were collected by filtration on a sintered glass funnel, washed with 200 mL of warm toluene, DMF, acetonitrile, followed by dispersion into 50% acetonitrile/water heated to 60° C., then collection by filtration and washing with acetonitrile and methanol (all solvents from Sigma-Millipore). The filter dried silica was further dried in a vacuum oven at 110° C. for at least 1 hour. The resulting 3-TPG bonded silica then underwent an additional bonding reaction in 250 mL of dimethylformamide (DMF, Sigma-Aldrich. St. Louis, MO), using 6 mmol of DIPEA, and 18 mmol of 3-TPG, at a temperature of 85° C. overnight, with occasional removal of about 5 mL of solvent through the Dean-Stark trap. After cooling, the solids are recovered by filtration, washing with 200 ml of warm DMF, then acetonitrile, followed by dispersion into 50% acetonitrile/water heated to 60° C., then collection by filtration and washing with acetonitrile and methanol. The silica was dried as before under vacuum at 110° C. The resulting 3-TPG bonded silica particles are densely bonded with 3-TPG, with elemental analysis typically revealing 3.5-3.8 μmol/m² on the silica surface.

### Peptide Modification

3-TPG bonded silica particles of Example 1 are dried in a vacuum oven for 2 hours. A suitable portion of 5-20 g of the material is dispersed in volume of 10 mL per g, using dry acetonitrile (Sigma-Aldrich, St. Louis, MO), then a quantity of 0.2 mmol/g of 4-dimethylaminopyridine (DMAP, Sigma-Aldrich) is added, with stirring at room temperature, followed by a quantity of disuccinimidylcarbonate (DSC, Oakland Chemicals), which was typically or 0.96 mmol/g (Rx 3c), added with stirring and dispersion in an ultrasonic bath. The reaction to form NHS activated intermediates proceeds for 1.5 hours at room temperature under nitrogen, after which each of these reaction mixtures are maintained separate, and the silica particles are collected on filter, washed with volumes of 25 mL/g of dry acetonitrile, THF, 20% of cold THF in 5 mM HCl in water, then THF, acetonitrile and methanol. After drying under vacuum at room temperature, the small sample of NHS activated TPG silica is dispersed at 50 mg/mL in 0.25 M NH₄OH for hydrolysis, and spectrophotometric assay of NHS content, as described by Li and Vanderah (2021). Activated 3-TPG silicas are dispersed in a peptide solution in acetonitrile reaction medium, at 10 mL/g silica solid in acetonitrile, with stirring. The peptide solution is prepared by dissolving various peptides, obtained from Biomatik Corporation (Kitchener Ontario, Canada). A suitable quantity of the peptide (1.2-1.5 molar equivalence to NHS present on the silica), is added to a quantity of acetonitrile suitable for forming a silica slurry at 10 mL/g. The peptide solution is rendered basic by addition of DIPEA at 1.1 molar equivalent to the quantity of peptide, which is generally obtained as a trifluoroacetate or hydrochloride salt. The peptide and activated silica slurry is allowed to stir overnight at room temperature, under a nitrogen gas blanket.

On completion of reaction, the peptide-modified TPG silica is collected by centrifugation (1500×g for 5 minutes), dispersed in acetonitrile, then washed twice by dispersion and collection using centrifugation in 10 mL/g of acetonitrile. Hydrolysis of remaining unreacted NHS modified sites was conducted by dispersing the silica particles in a solution of 0.2 M carbonate buffer (pH 9.5)/10% acetonitrile, with mixing for 30 minutes, followed by dispersion in 0.5 M Tris Buffer (pH 7.8) for 30 minutes. The modified silicas were then washed twice by dispersion and centrifugation in water, then collected by dispersion in 10 ml/g of water, vacuum filtration, and washing on filter with about 10 mL/g of acetonitrile and methanol, before drying on filter followed by vacuum oven drying at 110° C. In this example, peptides of particular sequence were selected, all of which were supplied with modification of the C-terminus by amidation.

Assay of the NHS modification on the surface of 3-TPG by the DSC reagent showed 0.52 μmol/m². The peptide-modified 3-TPG silicas were subjected to acid hydrolysis, then quantified using amino acid analysis (Creative Proteomics, Shirley, NY)). Quantification revealed the correct AA compositions, and high coverage (˜0.5 μmol/m² of the peptide on the packing material surface). The peptide-modified 3-TPG silicas were all similarly reacted, based on amino acid analysis. The ability to monitor activation density (UV), combined with post-reaction amino acid analysis, permits the ability to monitor this synthetic sequence.

### Chromatographic Properties of Peptide-Modified 3-TPG Silica

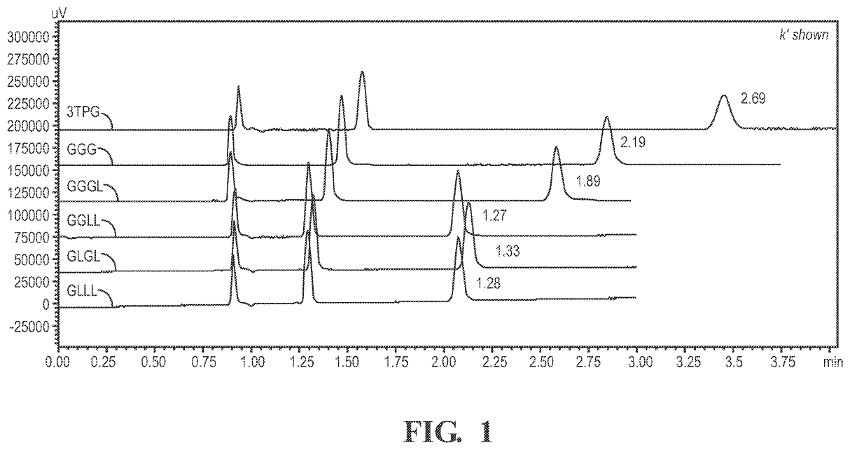

3-TPG and peptide-modified 3-TPG silicas were employed to load stainless steel HPLC columns of 2.1 internal diameter×100 mm length. These materials were applied to chromatographic separations of small polar nucleobase compounds, using hydrophobic interaction chromatography, examples of which are as shown in FIG. 1. Separation was accomplished using the Shimadzu Nexera LC instrument, at a flow rate of 0.25 mL/min, at a column temperature of 25° C., using a mobile phase composed of 92% acetonitrile/8% 0.1M ammonium formate (pH 3.0) in water. Detection of the nucleobases used absorbance at 260 nm. The greatest retention of these polar compounds occurs with unmodified 3-TGP silica, and is decreased with increasing hydrophobic side chain presence in the amino acid residues present in the peptide sequence. Separation of nucleobases using columns loaded with 3-TPG silica and peptide-modified 3-TPG silica. HILIC mode of separations of these three polar compounds shows lower retention with peptide sequences with compositions of with increased hydrophobic amino acid residues.

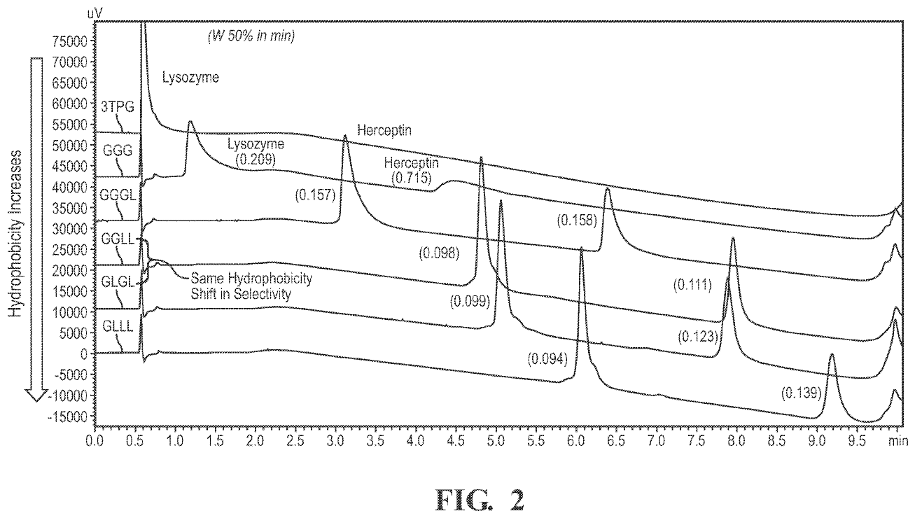

These same columns were tested for separations of known proteins in hydrophobic interaction chromatography, by injection of 1-2 uL of suitably diluted mixtures of proteins in the high ionic strength mobile phase. Separations were conducted by gradient elution, using a decrease in salt concentration to develop the separation. The mobile phases were delivered at 0.4 mL/min., with a column temperature of 30° C., with a gradient of 0-100% B over 8 minutes, in which mobile phase A was 2.0 M ammonium sulfate/0.02 M potassium phosphate (pH 7.0), and buffer B was 0.02 M potassium phosphate (pH 7.0). Chromatograms showing the separation of a mixture of two proteins, lysozyme and trastuzumab (herceptin), in HIC mode of separation are shown in FIG. 2. Notably, the retention of both proteins was lowest with unmodified 3-TPG silica, low for the simple GGG peptide segment, but increased for all peptide-modified 3TPG silicas, but most markedly with peptides of composition enriched in hydrophobic amino acids. Intermediate hydrophobic compositions (eg., GLGL and GGLL) were intermediate in retention, but these similarly hydrophobic peptides showed subtle differences in separation of these two proteins.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

1. A hydrophobic interaction chromatography (HIC) composition comprising:
a solid phase substrate; and
a hydrophobic-modified hydrophilic ligand covalently coupled to the solid phase substrate with the hydrophobic-modified ligand comprising;
a hydrophilic ligand portion covalently bonded to the solid phase substrate with the hydrophilic ligand portion including a polar group and a plurality of hydroxyl groups, and
a peptide segment, the peptide segment directly or indirectly covalently coupled to the hydrophilic ligand portion and comprising from two to twenty amino acid residues, including natural or non-natural amino acid residues,
wherein the peptide segment is linearly arranged and wherein each amino acid residue is the same as or different than the other amino acid residues for promoting HIC interactions.

2. The HIC composition of claim 1 wherein at least a majority of the amino acid residues of the peptide segment are neutral at pH values of 3 to 9 for promoting hydrophobic interaction.

3. The HIC composition of claim 1 wherein the peptide segment includes 2 to 7 amino acid residues.

4. (canceled)

5. The HIC composition of claim 1 wherein the peptide segment consists of residues selected from the group of natural amino acid residues, non-natural amino acid residues, and peptido-nucleic acid residues.

6. (canceled)

7. (canceled)

8. The HIC composition of claim 1 wherein the peptide segment extends to a terminal amino acid residue having a carboxy acid terminus that is blocked with an amide.

9. The HIC composition of claim 1 wherein each amino acid residue of the peptide segment is neutral at pH values of 3 to 9.

10. The HIC composition of claim 1 wherein the hydrophobic-modified hydrophilic ligand is represented by Formula I: 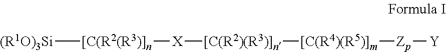
wherein:
X is the polar group;
Z is a connecting group;
Y is the peptide segment;
n is 1-6;
n′ is 0-2;
m is 2-8;
p is 0 or 1;
R¹, R², R³, is independently H or a straight or branched, substituted or unsubstituted, C1 to C18 alkyl group; and
R⁴ and R⁵ is independently H or OH and at least two m units include at least one hydroxyl group.

11. The HIC composition of claim 10 wherein the hydrophilic ligand portion is represented by Formula Ia: 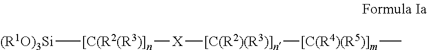
wherein:
X is the polar group;
n is 1-6;
n′ is 0-2;
R¹, R², R³, is independently H or a straight or branched, substituted or unsubstituted, C1 to C18 alkyl group; and
R⁴ and R⁵ is independently H or OH and at least two m units include at least one hydroxyl group.

12. (canceled)

13. (canceled)

14. The HIC composition of claim 11 wherein the polar group X is an amide.

15. The HIC composition of claim 14 wherein:
n is 2-4;
m is 3-6;
p is 1;
R¹, R², R³, is independently H or a straight or branched, substituted or unsubstituted, C1 to C6 alkyl group; and
the connecting group Z is a carbamate group.

16. (canceled)

17. The HIC composition of claim 10 wherein the hydrophobic-modified hydrophilic ligand is represented by Formula II:

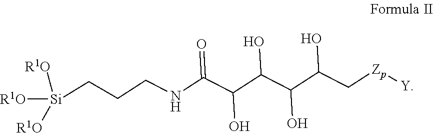

18. The HIC composition of claim 1 wherein amino acid residues of the peptide segment are derived from amino acids selected from the group of glycine (Gly), leucine (Leu), alanine (Ala), Isoleucine (Ile), valine (Val), methionine (Met), cysteine (Cys), proline (Pro), phenylalanine (Phe), tryptophan (Trp), tyrosine (Tyr), and combinations thereof.

19. The HIC composition of claim 18 wherein the peptide segment includes amino acid residues derived from amino acids selected from the group of glycine (Gly), leucine (Leu), and combinations thereof.

20. The HIC composition of claim 19 wherein the peptide segment is selected from the group of:

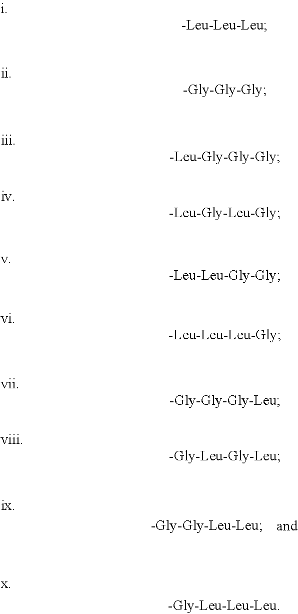

21. The HIC composition of claim 1 wherein the peptide segment is represented by:

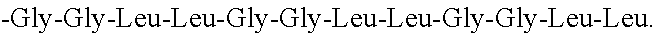

22. The HIC composition of claim 20 wherein each amino acid residue is neutral at a pH value of 3 to 9.

23. The HIC composition of claim 10 wherein the hydrophobic-modified hydrophilic ligand is represented by Formula III:

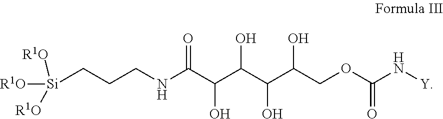

24. The HIC composition of claim 1 further comprising a hydrophilic ligand, different than the hydrophobic-modified hydrophilic ligand, covalently bonded to the solid phase substrate with the hydrophilic ligand including a polar group and a plurality of hydroxyl groups, wherein the hydrophilic ligand is represented by Formula Va:

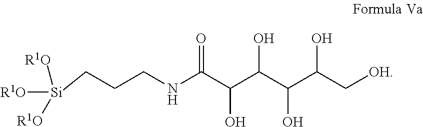

25.-29. (canceled)

30. A kit comprising the HIC composition of claim 1.

31. (canceled)

32. A method of producing a hydrophobic interaction chromatography (HIC) composition including a hydrophobic-modified hydrophilic ligand, the method comprising:
providing a solid phase substrate;
providing a hydrophilic ligand portion including a polar group and a plurality of hydroxyl groups;
reacting the solid phase substrate and the hydrophilic ligand portion to covalently couple the hydrophilic ligand portion to the solid phase substrate to form a hydrophilic-modified substrate;
providing an activation compound including a leaving group;
reacting the activation compound with one of the plurality of hydroxyl groups to form an activated hydrophilic-modified substrate;
providing a peptide segment comprising from two to twenty amino acid residues, including natural or non-natural amino acid residues; and
reacting the activated hydrophilic-modified substrate with the peptide segment to release the leaving group of the activation compound and form the hydrophobic-modified hydrophilic ligand and the HIC composition;
wherein the peptide segment is linearly arranged and each amino acid residue is the same as or different than the other amino acid residues for promoting HIC interaction.

33. The method of claim 32 wherein the peptide segment includes 2 to 7 amino acid residues and at least a majority of the amino acid residues of the peptide segment are neutral at pH values of 3 to 9 for promoting hydrophobic interaction.

34.-40. (canceled)

41. The method of claim 32 further comprising reacting the solid phase substrate and a hydrophilic ligand represented by Formula V: 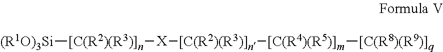
wherein:
X is the polar group;
n is 1-6;
n′ is 0-2;
m is 2-8;
q is 1;
R¹, R², R³, is independently H or a straight or branched, substituted or unsubstituted, C1 to C18 alkyl group;
R⁴ and R⁵ is independently H or OH and at least two m units include at least one hydroxyl group; and
R⁸ and R⁹ is independently H or OH provided that at least one of R⁸ and R⁹ is OH to represent the hydroxyl group present at the terminus of the hydrophilic ligand.

42. (canceled)

43. The method of claim 41 wherein the polar group X is selected from an amide, a carbamate, or ureido group.

44.-46. (canceled)

47. The method of claim 32 wherein amino acid residues of the peptide segment are derived from amino acid selected from the group of glycine (Gly), leucine (Leu), alanine (Ala), Isoleucine (Ile), valine (Val), methionine (Met), cysteine (Cys), proline (Pro), phenylalanine (Phe), tryptophan (Trp), tyrosine (Tyr), and combinations thereof.

48. (canceled)

49. The method of claim 32 wherein the peptide segment is selected from the group of:

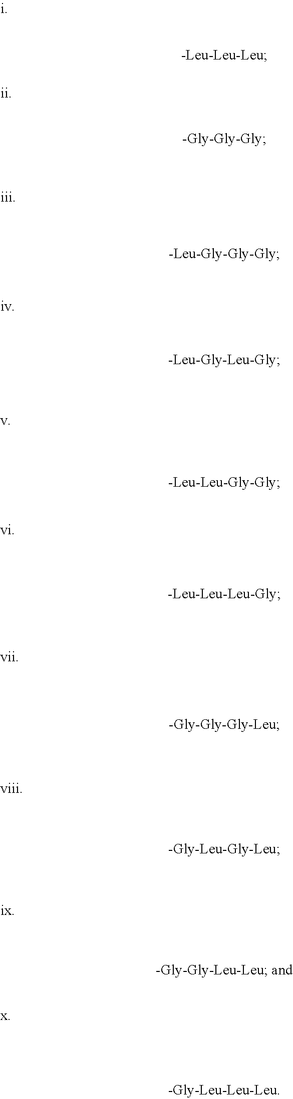

50. The method of claim 41 wherein the hydrophobic-modified hydrophilic ligand is represented by Formula III:

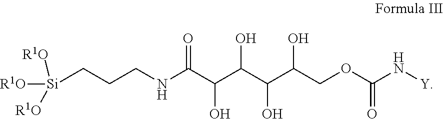

51.-57. (canceled)
